(19) United States
(12) Patent Application Publication
(10) Pub. No.: US 2016/0234789 A1
(43) Pub. Date: Aug. 11, 2016

(54) METHOD OF CONTROLLING TRANSMISSION POWER IN DEVICE-TO-DEVICE COMMUNICATION AND APPARATUS THEREOF

(71) Applicant: ELECTRONICS AND TELECOMMUNICATIONS RESEARCH INSTITUTE, Daejeon (KR)

(72) Inventors: Sung-Min OH, Daejeon (KR); Changhee LEE, Seoul (KR); Ae-Soon PARK, Daejeon (KR); JaeSheung SHIN, Daejeon (KR); Jeong Hwan LEE, Hwaseong-Si (KR)

(73) Assignee: ELECTRONICS AND TELECOMMUNICATIONS RESEARCH INSTITUTE, Daejeon (KR)

(21) Appl. No.: 15/016,246

(22) Filed: Feb. 4, 2016

(30) Foreign Application Priority Data
Feb. 5, 2015 (KR) 10-2015-0018237

(51) Int. Cl. H04W 52/24; H04W 4/06; H04W 76/02

(52) U.S. Cl. CPC H04W 52/241; H04W 76/023; H04W 4/06

(57) ABSTRACT

Disclosed are a method and an apparatus for controlling distributed transmission power in device-to-device (D2D) communication. The D2D devices individually control their transmission power for the D2D communication link. In addition, a first terminal calculates the transmission power based on the measured channel gain and interference-plus-noise level. The first terminal determines optimal transmission power based on the calculated transmission power by the first terminal, and transmits a transmission power change message including the optimal transmission power to a second terminal. Next, the second terminal transmits a D2D signal based on the optimal transmission power.

### CROSS-REFERENCE TO RELATED APPLICATION

This application claims priority to and the benefit of Korean Patent Application No. 10-2015-0018237 filed in the Korean Intellectual Property Office on Feb. 5, 2015, the entire contents of which are incorporated herein by reference.

### BACKGROUND OF THE INVENTION

(a) Field of the Invention

The present invention relates to a method of controlling power of a transmission signal. More particularly, the present invention relates to a method and an apparatus for controlling distributed transmission power in device-to-device (D2D) communication.

(b) Description of the Related Art

In recent years, with the development of a wireless communication system, Device-to-Device (hereinafter referred to as D2D′) communication has been spotlighted. Particularly, a, LTE-Advanced technology is commercially available so that a D2D communication scheme has been increasingly researched.

D2D communication is direct communication between communication terminals in a mobile communication system. That is, the D2D communication means communication that directly exchanges data without passing through a base station. The base station in the D2D communication manages resources, a transmission state, and the like of the D2D communication terminal. The base station analyzes a status of the D2D communication terminal by continuously exchanging a control signal with a communication terminal, and controls the D2D communication terminal based on the analyzed status of the D2D communication terminal.

There is a transmission power control technology that takes into consideration battery consumption of a terminal and interference between communication links in the D2D communication.

According to the power control technology used in existing cellular communication, a base station measures uplink signal quality of a specific terminal. When the measured numerical value is different from a target numerical value, the base station transmits information on a difference between the measure numerical value and the target numerical value to the terminal to adjust transmission power of the terminal. In this case, the base station adds the information on the target numerical value and the measured numerical value to f(i) of a downlink control information (DCI) format to transmit f(i) of a DCI format to the terminal.

When the power control technology used in the above cellular communication is applied to a D2D communication environment, the following problems occur.

In detail, in a state in which interference is generated between D2D communication links, when the terminal adjusts transmission power of a D2D communication link in order to obtain only target signal quality of the terminal, an interference influence on other D2D communication link is also changed. Accordingly, entire cell performance may be deteriorated.

Further, in order to perform closed-loop power control, the base station should know signal quality of a D2D communication link. To this end, the drawback of the D2D communication environment is that a D2D reception terminal should measure signal quality between D2D communication links every transmission time interval (TTI) to directly transmit the measured signal quality to the base station, and transmits information on the measured signal quality to the D2D transmission terminal so that the D2D transmission terminal should transfer the information on the measured signal quality.

### SUMMARY OF THE INVENTION

The present invention has been made in an effort to provide a method of controlling transmission power in device-to-device (D2D) communication and an apparatus thereof having advantages of efficiently distributed-controlling transmission power in the D2D communication.

An exemplary embodiment of the present invention provides a method of controlling distributed transmission power by D2D communication links in a network environment to perform D2D communication, the method including: measuring a channel gain and interference-plus-noise level with respect to the D2D communication link to calculate transmission power based on the measured channel gain and interference-plus-noise level by a first terminal; determining optimal transmission power based on the calculated transmission power by the first terminal; and transmitting a transmission power change message including the optimal transmission power to a second terminal by the first terminal, wherein the second terminal transmits a D2D signal based on the optimal transmission power.

The method may further include triggering transmission power control with respect to the D2D communication link by a base station.

The method may further include transmitting a transmission power change request message to the base station by the first terminal. In this case, the triggering of the transmission power control may include triggering transmission power change of the D2D communication links based on the transmission power change request message by the base station.

The triggering of the transmission power change may include: broadcasting a message for triggering the transmission power change of the D2D communication links by the base station when a transmission power change request message is received from D2D

The transmitting of the transmission power change request message to the base station by the first terminal may include: measuring an average Signal-to-Interference plus Noise Ratio (SINR) based on a signal received by the first terminal; and transmitting a transmission power change request message to the base station by the first terminal when the measured average SINR is less than a preset level during a preset time.

The method may further include triggering transmission power control with respect to the D2D communication link by the first terminal after the transmitting of the transmission power change message including the optimal transmission power to the second terminal. The triggering of the transmission power control with respect to the D2D communication link may include broadcasting a message including distributed power control parameters to update transmission power to peripheral D2D terminals by the first terminal.

The broadcasting of the message to the peripheral D2D terminals may include: measuring an average SINR based on a received signal by the first terminal; and broadcasting a message including distributed power control parameters to peripheral D2D terminals by the first terminal when the measured average SINR is less than a preset level during a preset time.

The determining of the optimal transmission power based on the calculated transmission power by the first terminal may include: monitoring a difference between an n-th calculated transmission power and an (n+1)-th calculated transmission power; and determining the n-th calculated transmission power as optimal transmission power when the difference is less than a preset value.

The calculating of the transmission power may further include: transmitting a power transmission change message including the calculated transmission power to a second terminal by the first terminal; and updating distributed power parameters based on the calculated power transmission power. The calculation of the transmission power and transmission and update of the power transmission change message may be repeated.

The method may further include: receiving a power transmission change message including the transmission power by the second terminal; comparing the transmission power included in the power transmission change message with maximum transmission power by the second terminal; determining an equal or smaller value of the transmission power included in the power transmission change message and the maximum transmission power as the transmission power; and processing a D2D signal according to the determined transmission power to transmit the processed D2D signal by the second terminal.

The method may further include receiving a message including distributed power control parameters broadcasted from the base station by the first terminal before the calculating of the transmission power.

The method may further include broadcasting a message including distributed power control parameters to peripheral D2D terminals by the first terminal before the calculating of the transmission power.

Another embodiment of the present invention provides an apparatus for controlling transmission power in a network environment to perform D2D communication, the apparatus including: a wireless frequency converter configured to transmit/receive a signal through an antenna; and a processor connected to the wireless frequency converter and configured to control transmission of the signal. The processor includes: a transmission power calculator configured to measure a channel gain and interface with respect to a D2D communication link based on the received signal to calculate D2D transmission power based on the measured channel gain and interface; an optimal transmission power determining unit configured to determine optimal transmission power based on the calculated transmission power; and a transmission power change request unit configured to transmit a transmission power change message including the optimal transmission power to a terminal of another party, wherein the terminal of the other party transmits a D2D signal based on the optimal transmission power.

The transmission power change request unit may measure an average SINR after the optimal transmission power is determined, and transmit a transmission change request message to a base station when the measured average SINR is maintained with a preset level or less for a preset time.

When a transmission power change request message is received from a D2D communication link of a preset ratio or greater among D2D communication links for a preset time, the base station may broadcast a message for triggering transmission power change of the D2D communication links, and the apparatus for controlling transmission power may again perform transmission power control for determining an optimal transmission power with respect to a corresponding D2D communication link.

The transmission power change request unit may measure an average SINR when the optimal transmission power is determined, and broadcast a message including a distributed power control parameter to peripheral D2D terminals when the measured average SINR is maintained with a preset level or less for a preset time.

The optimal transmission power determining unit may determine an n-th calculated transmission power as optimal transmission power when a difference between the n-th calculated transmission power and an (n+1)-th calculated transmission power is less than a preset optional value.

The processor may further include a power control parameter update unit configured to update a distributed power parameter based on the calculated power transmission power. The transmission power change request unit may transmit a power transmission change message including transmission power corresponding to the transmission power calculated by the transmission power calculator to a terminal of another party.

The processor may include: a transmission power selector configured to select a smaller value of transmission power included in a received power transmission change message and maximum transmission power of the apparatus when a power transmission change message including transmission power is received from a terminal of another party; and a signal processor configured to process a D2D signal according to the transmission power selected by the transmission power selector to transmit the processed D2D signal to the terminal of the other party.

### BRIEF DESCRIPTION OF THE DRAWINGS

FIG. 1 is a block diagram illustrating a network environment according to an exemplary embodiment of the present invention.

FIG. 2 is a flowchart illustrating a distributed transmission power control method according to an exemplary embodiment of the present invention.

FIG. 3 is a flowchart illustrating a distributed transmission power control method according to another exemplary embodiment of the present invention.

FIG. 4 is a block diagram illustrating a configuration of a transmission power control apparatus according to an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, In addition, unless explicitly described to the contrary, the word “comprise” and variations such as “comprises” or “comprising” will be understood to imply the inclusion of stated elements but not the exclusion of any other elements.

Hereinafter, a method and an apparatus for control transmission power according to an exemplary embodiment of the present invention will be described.

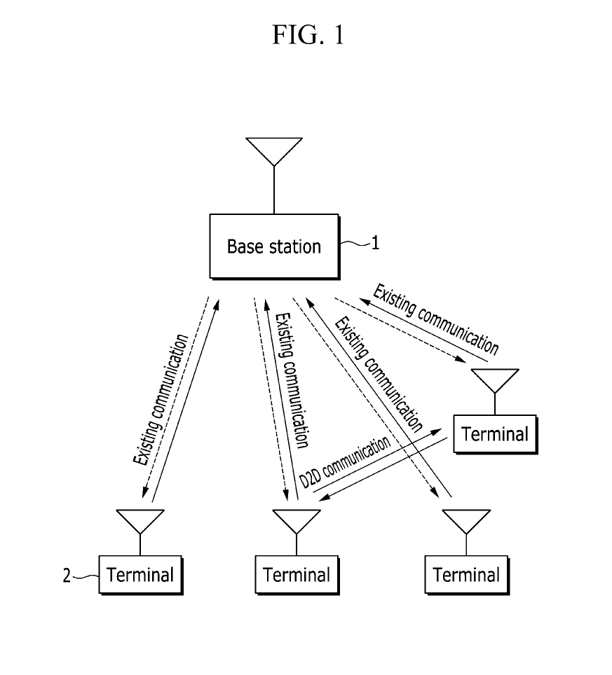

FIG. 1 is a block diagram illustrating a network environment according to an exemplary embodiment of the present invention.

As shown in FIG. 1, a base station 1 transmits a downlink signal to a plurality of terminals 2, and receives an uplink signal from each terminal. The downlink signal is marked with a dotted line. In the device-to-device (D2D) communication using LTE-Advanced, each terminal, that is, D2D terminal 2, receives a downlink signal of a base station 1 and transmits an uplink signal. The uplink signal is marked with a solid line.

Moreover, the terminal 2 may exchange a D2D signal with other terminals. Since a D2D signal is exchanged using the uplink bandwidth upon the D2D communication, a terminal 2 cannot simultaneously transmit/receive the uplink signal.

An exemplary embodiment of the present invention performs the distributed transmission power control in the above D2D communication environment.

In order to maximize the sum of the spectrum efficiency of the D2D communication links, the transmission power is dispersively adjusted by D2D communication links based on Network Utility Maximization theory. Further, so as to reduce the signaling overhead, the calculated transmission power value is semi-statically used for the D2D communication.

Further, when the Signal-to-Interference plus Noise Ratio (SINR) of a D2D link is less than a preset threshold during a preset time, the D2D terminal can request the update of the transmission power to the base station. Then, the base station triggers the distributed power control operation by broadcasting a control message such as a system information block (SIB) or a radio resource control (RRC) message.

The distributed transmission power control according to an exemplary embodiment of the present invention may be initiated by the base station or a terminal.

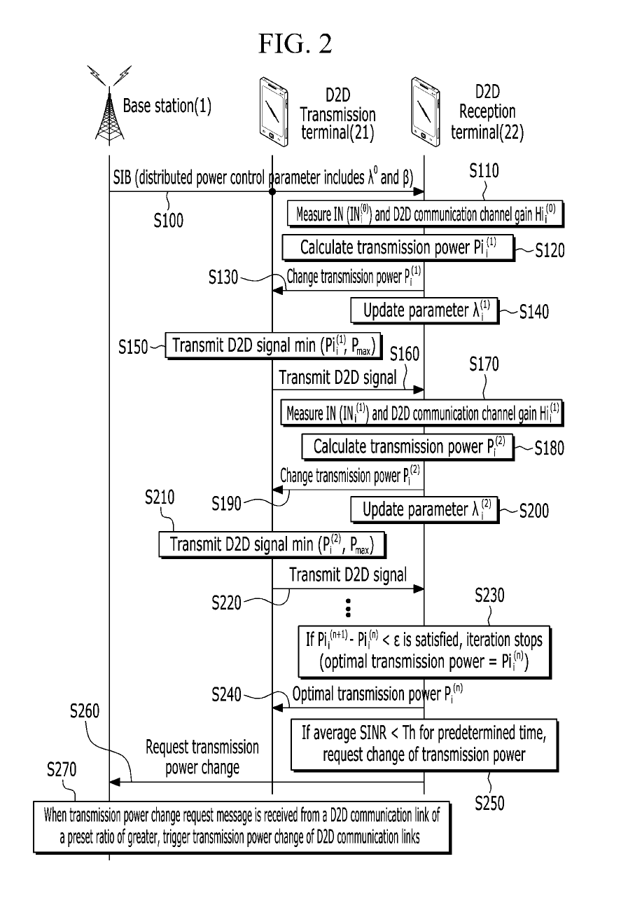

FIG. 2 is a flowchart illustrating a distributed transmission power control method according to an exemplary embodiment of the present invention.

Hereinafter, a corresponding method will be described based on a disclosure of the distributed transmission power control by the base station.

As shown in FIG. 2, the base station 1 provides the preset parameters for the distributed power control between D2D communication links to D2D terminals (S100). The preset parameters for the distributed power control between D2D communication links may refer to the distributed power control parameters, and the distributed power control parameters include λ⁰ and β. In this case, λ⁰ represents an initial distributed power control parameter. The β represents the size of a step of converging to an optimal value, and represents a size of an iteration step for converging a transmission power value calculated upon iteration in the distributed power control method to be described below. The base station 1 adds the above distributed power control parameter to a SIB message, and transmits the SIB message to terminals.

A D2D reception terminal 22 measures a channel gain and interference—plus-noise level with respect to the D2D communication link (S110). The D2D reception terminal 22 measures a D2D communication channel gain Hᵢ⁽ⁿ⁾ and interference, that is, IN (Interference plus Noise level: INᵢ⁽ⁿ⁾) based on a reference signal transmitted from a D2D transmission terminal 21, for example, a DeModulation Reference Signal (DMRS).

Further, the D2D reception terminal 22 calculates the D2D transmission power based on the measured channel gain and interference—plus-noise level (S120). In this case, the D2D transmission power may be calculated as follows.

Pᵢ⁽ⁿ⁺¹⁾=max_{P}_{ᵢ}{Uᵢ(γᵢ(Pᵢ,INᵢ⁽ⁿ⁾,Hᵢ⁽ⁿ⁾))−λᵢ⁽ⁿ⁾·Pᵢ} [Equation 1]

Herein, the Pᵢ⁽ⁿ⁺¹⁾ represents the transmission power in an (n+1)-th iteration of an i-th D2D communication link. The n represents the index number of the iteration. The Uᵢ(γᵢ) is a utility function, and Uᵢ=(γᵢ)=log₂(1+γi) is applicable.

Further, the INᵢ⁽ⁿ⁾ represents interference (IN) in an n-th iteration, and the Hᵢ⁽ⁿ⁾ represents a D2D communication channel gain in the n-th iteration. The λᵢ⁽ⁿ⁾ represents a distributed power control parameter in the n-th iteration.

The D2D reception terminal 22 transmits the D2D transmission power calculated based on the measured channel gain and interference-plus-noise level to the D2D transmission terminal 21 (S130). In detail, the D2D reception terminal 22 adds the calculated transmission power to a transmission power change message and transmits the message to the D2D transmission terminal 21.

Further, the D2D reception terminal 22 updates the distributed transmission power parameters of the D2D reception terminal 22 (S140). In detail, the D2D reception terminal 22 updates the distributed transmission power parameter as follows.

λᵢ⁽ⁿ⁺¹⁾=[λᵢ⁽ⁿ⁾+β·(Pᵢ⁽ⁿ⁾−P̅)]⁺ [Equation 2]

Herein, the λᵢ⁽ⁿ⁺¹⁾ represents the updated division transmission parameter. The [•]⁺ represents that “•” is greater than 0, and the β represents the step size to be used for the convergence of the transmission power. Further, the P̅ represents the maximum transmission power.

The D2D transmission terminal 21 receives a transmission power change message from the D2D reception terminal 22, and the D2D transmission terminal 21 compares the transmission power included in the received transmission power change message with the preset maximum transmission power. The maximum transmission power may be acquired from the SIB message including the power control parameters transmitted from the base station 1. The D2D transmission terminal 21 selects the transmission power having a smaller value between the transmission power included in the received transmission power change message and the preset maximum transmission power (S150).

Next, the D2D transmission terminal 21 transmits a D2D signal using the selected transmission power (S160). In this case, the D2D signal may represent a data signal or a control signal including a reference signal.

The D2D reception terminal 22 again measures a channel gain and interference-plus-noise level with respect to the D2D communication link. That is, the D2D reception terminal 22 measures interference-plus-noise level and a D2D communication channel gain based on a D2D signal received from the D2D transmission terminal 21 (S170). In addition, the D2D reception terminal 22 again calculates the D2D transmission power and the distributed power parameters based on the measured interference-plus-noise level and the D2D communication channel gain (S180). In this case, the D2D transmission power and distributed power parameters can be calculated based on Equation 1 and Equation 2.

Next, the D2D reception terminal 21 may add the calculated D2D transmission power, that is, the transmission power, to a transmission power change message and transmit the transmission power change message to the D2D transmission terminal 21 (S190). In this case, when a difference between the previously calculated transmission power and a currently calculated transmission power is greater than a preset value c, the D2D reception terminal 21 may transmit the transmission power change message including the currently calculated transmission power to the D2D transmission terminal 21.

The D2D reception terminal 21 again calculates the D2D transmission power, and updates the distributed transmission power parameters based on Equation 2 (S200).

The D2D transmission terminal 21 receives a transmission power change message including the transmission power from the D2D reception terminal 22, and selects the transmission power having a smaller value between the transmission power included in the received transmission power change message and the preset maximum transmission power (S210). Further, the D2D transmission terminal 21 transmits the D2D signal to the D2D reception terminal 21 using the selected transmission power (S220).

The calculation of the transmission power, the signal transmission, and the update process of the distributed power parameter between the D2D transmission terminal 21 and the D2D reception terminal 22 are repeated. Next, when a difference between transmission power calculated in an n-th iteration and transmission power calculated in an (n+1)-th iteration is less than a preset value c, the D2D reception terminal 22 stops the iteration process. After that, the D2D reception terminal 22 uses the transmission power Pᵢ⁽ⁿ⁾ calculated in the n-th iteration as optimal transmission power (S230). The D2D reception terminal 22 transmits a message including the optimal transmission power to the D2D transmission terminal 21 (S240). Next, the D2D transmission terminal 21 transmits the D2D signal continuously using the optimal transmission power.

Meanwhile, the D2D reception terminal 22 transmits a message including the optimal transmission power to the D2D transmission terminal 21, and continuously measures the average SINR. After that, when the measured average SINR is less than the preset level during the preset time, the D2D reception terminal 22 transmits the transmission power change request message to the base station 1 (S250 and S260).

Meanwhile, when receiving the above transmission power change request message from D2D terminals, the base station 1 triggers the transmission power change of the D2D communication links (S270). That is, the base station 1 adds the distributed power control parameters λ⁰ and β to a control message such as the SIB message or RRC message to transmit the addition result to all D2D terminals so that the distributed transmission power control operation is triggered. According to the above distributed transmission power control operation, the above steps S100 to S260 are again performed so that the optimal transmission power is set by D2D communication links.

Meanwhile, in the above distributed transmission power control method, steps S130 and S190 of transmitting the calculated D2D transmission power to the D2D transmission terminal 21 and steps S140 and S180 of updating the distributed transmission power parameters are not limited to the above order. For example, after updating the distributed transmission power parameter, the D2D transmission power may be transmitted to the D2D transmission terminal 21.

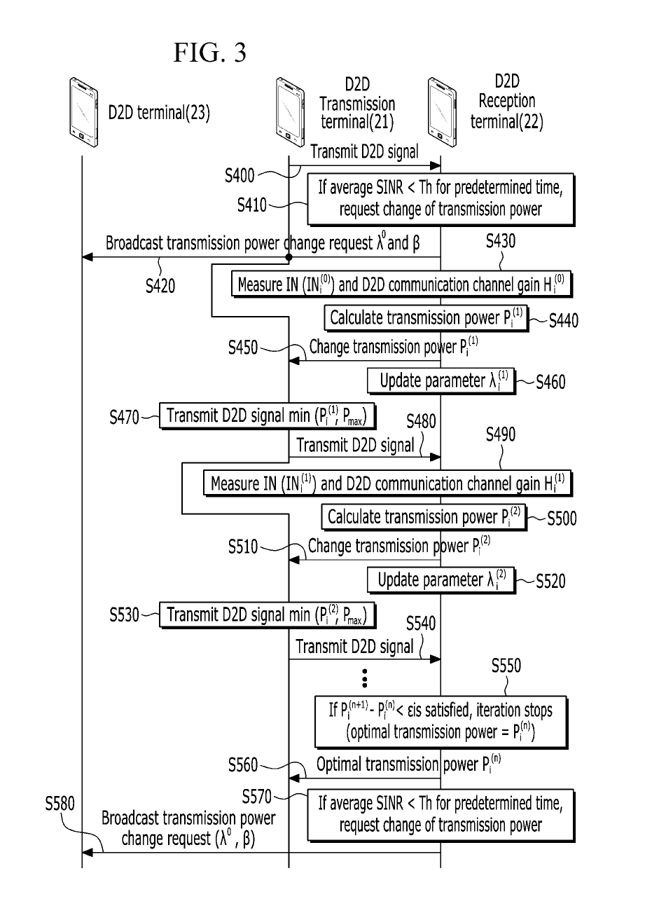

FIG. 3 is a flowchart illustrating a distributed transmission power control method according to another exemplary embodiment of the present invention.

Hereinafter, a corresponding method will be described based on a disclosure of the distributed transmission power control by the terminal. A detailed description of the process performed similar to the above exemplary embodiment is omitted.

As shown in FIG. 3, the D2D transmission terminal 21 is configured so that the D2D reception terminal 22 receiving the D2D signal from the D2D transmission terminal 21 continuously measures the average SINR (S400). Next, when the measured average SINR is less than the preset threshold during the preset time, the D2D reception terminal 22 broadcasts the distributed power control parameters to peripheral D2D terminals 23 (S410 and S420). The D2D reception terminal 22 broadcasts the transmission power change request message including the distributed power control parameters λ⁰ and β to the peripheral D2D terminals 23.

The D2D reception terminal 22 measures a channel gain and interference-plus-noise level with respect to the D2D communication link (S430). The D2D reception terminal 22 measures a D2D communication channel gain Hᵢ⁽ⁿ⁾ based on a D2D signal (including DMRS) transmitted from the D2D transmission terminal 21 and interference-plus-noise level, INᵢ⁽ⁿ⁾. (S430). Further, the D2D reception terminal 22 calculates the D2D transmission power based on the measured channel gain and interference-plus-noise level (S440). In this case, the D2D transmission power can be calculated by the above Equation 1.

The D2D reception terminal 22 adds the D2D transmission power calculated based on the measured channel gain and interference-plus-noise level to a transmission power change message, and it transmits the transmission power change message to the transmission terminal 21 (S450).

Further, after transmitting the transmission power change message, the D2D reception terminal 22 updates the distributed transmission power parameters of the D2D reception terminal 22 with reference to Equation 2 (S460).

The D2D transmission terminal 21 selects the transmission power having a smaller value between the transmission power included in the transmission power change message received from the D2D reception terminal 22 and the maximum transmission power, and transmits a D2D signal using the selected transmission power (S470 and S480).

When the D2D reception terminal 22 receives the D2D signal, the D2D reception terminal 22 again measures a channel gain and interference-plus-noise level with respect to the D2D communication link (S490). The D2D reception terminal 22 again calculates the D2D transmission power based on the interference-plus-noise level and the channel gain of the D2D link (S500). The D2D reception terminal 22 adds the calculated D2D transmission power to the transmission power change message and transmits the transmission power change message to the D2D transmission terminal 21 (S510). In this case, when a difference between the previously calculated transmission power and the currently calculated transmission power is greater than the preset value c, the D2D reception terminal 21 may transmit the transmission power change message including the currently calculated transmission power to the D2D transmission terminal 21. Further, the D2D reception terminal 22 updates the distributed transmission power parameters of the D2D reception terminal 22 (S520).

The D2D transmission terminal 21 receives the transmission power change message including the transmission power from the D2D reception terminal 22, and selects the transmission power having a smaller value between the transmission power included in the received transmission power change message and the maximum transmission power (S530). In addition, the D2D transmission terminal 21 transmits the D2D signal to the D2D reception terminal 21 using the selected transmission power (S540).

The calculation of the transmission power, the signal transmission, and the update process of the distributed power parameter between the D2D transmission terminal 21 and the D2D reception terminal 22 are repeated. Next, when a difference between the transmission power calculated in an n-th iteration and the transmission power calculated in an (n+1)-th iteration is less than a preset value c, the D2D reception terminal 22 stops the iteration process. After that, the D2D reception terminal 22 selects the transmission power Pᵢ⁽ⁿ⁾ calculated in the n-th iteration as the optimal transmission power (S550).

The D2D reception terminal 22 transmits a message including the optimal transmission power to the D2D transmission terminal 21 (S560). Next, the D2D transmission terminal 21 transmits the D2D signal continuously using the optimal transmission power.

Meanwhile the D2D reception terminal 22 transmits a message including the optimal transmission power to the D2D transmission terminal 21, and it continuously measures an average SINR. When the measured average SINR is less than the predefined level during the preset time, the D2D reception terminal 22 broadcasts the distributed power control parameters to the peripheral D2D terminals 23 (S570 and S580).

According to the distributed transmission power control operation of the D2D reception terminal 22, the above steps S430 to S580 are again performed so that optimal transmission power is set by D2D communication links.

In this case, steps S450 and S510 of transmitting the calculated D2D transmission power to the D2D transmission terminal 21, and steps S460 and S520 of updating the distributed transmission power parameter, are not limited the above order. For example, the distributed transmission power parameter is updated so that the D2D transmission power may be the D2D transmission terminal 21.

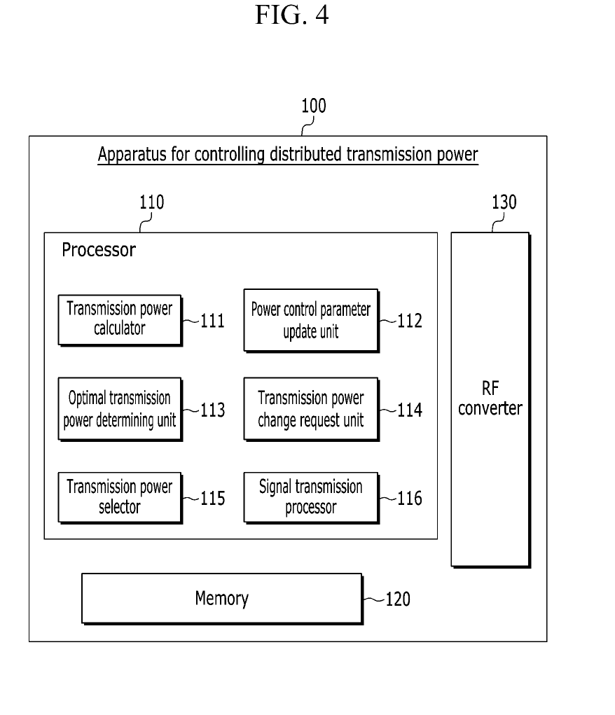

FIG. 4 is a block diagram illustrating a configuration of a transmission power control apparatus according to an exemplary embodiment of the present invention.

As shown in FIG. 4, the distributed transmission power control apparatus 100 includes a processor 110, a memory 120, and a radio frequency (RF) converter 130. The processor 110 may be configured by implementing the above steps and methods based on FIG. 1 to FIG. 3.

For this purpose, the processor 110 includes a transmission power calculator 111, a power control parameter update unit 112, an optimal transmission power determining unit 113, and a transmission power change request unit 114. In addition, the processor 110 may include a transmission power selector 115 and a signal transmission processor 116.

The transmission power calculator 111 measures a channel gain and interference based on a reference signal (which may be transmitted from a terminal of the other party forming the D2D communication link), and calculates the D2D transmission power based on this. The D2D transmission power may be calculated based on Equation 1. The transmission power calculator 111 may receive a distributed power control parameter from the base station. The distributed power control parameter includes λ⁰ and β.

The power control parameter update unit 112 updates a distributed transmission power parameter based on the D2D transmission power according to the transmission power calculator 11.

The optimal transmission power determining unit 113 stops iterations when a difference between transmission power calculated in an n-th iteration and transmission power calculated in an (n+1)-th iteration in a state that a process of calculating the transmission power and updating the parameter is repeated a plurality of times. Further, the transmission power calculated in the n-th iteration is determined as optimal power.

The transmission power change request unit 114 transmits a transmission power change message including transmission power corresponding to D2D transmission power calculated by the transmission power calculator 111 to the terminal of the other party of the D2D communication link.

Further, the transmission power change request unit 114 may transmit the transmission power change request message to the base station. After determining the optimal transmission power by the optimal transmission power determining unit 113, the transmission power change request unit 114 measures an average SINR. When the measured average SINR is maintained with a preset level or less for a preset time, the transmission power change request unit 114 transmits the transmission power change request message to the base station 1. Further, the transmission power change request unit 114 measures an average SINR after the determination of the optimal transmission power. When the measured average SINR is maintained with a preset level or less for a preset time, the transmission power change request unit 114 broadcasts a message including a distributed power control parameter to peripheral terminals.

Meanwhile, when receiving the transmission power change message including the transmission power from the terminal of the other party of the D2D communication link, the transmission power selector 115 compares transmission power included in the transmission power change message with preset maximum transmission power. The transmission power selector 115 selects transmission power having a smaller value from the transmission power included in the transmission power change message with preset maximum transmission power.

The signal transmission processor 116 transmits the D2D signal as transmission power selected by the transmission power selector 115. The D2D signal may include a data signal or a reference signal.

The memory 120 is connected to a processor 11 and stores various information associated with an operation of the processor 110. The RF converter 130 is connected to the processor 110 and transmits or receives a wireless signal.

In an exemplary embodiment of the present invention, without exchange of information between the base station and the D2D communication link in the D2D communication environment, optimal transmission power between D2D communication links in order to maximize a sum of spectrum efficiencies of the network may be determined in a distributed scheme. Accordingly, network performance may be improved while reducing signaling overhead.

The exemplary embodiment of the present invention described above is implemented not only by an apparatus and a method, but also by a program realizing a function corresponding to a configuration of the exemplary embodiment of the present invention or a recording medium recording the program.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A method of controlling distributed transmission power by device-to-device (D2D) communication links in a network environment to perform D2D communication, the method comprising:
measuring a channel gain and interference-plus-noise level with respect to the D2D communication link to calculate transmission power based on the measured channel gain and interference-plus-noise level by a first terminal;
determining optimal transmission power based on the calculated transmission power by the first terminal; and
transmitting a transmission power change message including the optimal transmission power to a second terminal by the first terminal,
wherein the second terminal transmits a D2D signal based on the optimal transmission power.

2. The method of claim 1, further comprising triggering transmission power control with respect to the D2D communication link by a base station.

3. The method of claim 2, further comprising transmitting a transmission power change request message to the base station by the first terminal, and
the triggering of the transmission power control comprises triggering transmission power change of the D2D communication links based on the transmission power change request message by the base station.

4. The method of claim 3, wherein the triggering of the transmission power change comprises: broadcasting a message for triggering the transmission power change of the D2D communication links by the base station when a transmission power change request message is received from D2D devices.

5. The method of claim 3, wherein the transmitting of the transmission power change request message to the base station by the first terminal comprises:
measuring an average Signal-to-Interference plus Noise Ratio (SINR) based on a signal received by the first terminal; and
transmitting a transmission power change request message to the base station by the first terminal when the measured average SINR is less than a preset level during a preset time.

6. The method of claim 1, further comprising triggering transmission power control with respect to the D2D communication link by the first terminal after the transmitting of the transmission power change message including the optimal transmission power to the second terminal.

7. The method of claim 6, wherein the triggering of the transmission power control with respect to the D2D communication link comprises broadcasting a message including distributed power control parameters to update transmission power to peripheral D2D terminals by the first terminal.

8. The method of claim 7, wherein the broadcasting of the message to the peripheral D2D terminals comprises:
measuring an average SINR based on a received signal by the first terminal; and
broadcasting a message including distributed power control parameters to peripheral D2D terminals by the first terminal when the measured average SINR is less than a preset level during a preset time.

9. The method of claim 1, wherein the determining of the optimal transmission power based on the calculated transmission power by the first terminal comprises:
monitoring a difference between an n-th calculated transmission power and an (n+1)-th calculated transmission power; and
determining the n-th calculated transmission power as optimal transmission power when the difference is less than a preset value.

10. The method of claim 1, wherein the calculating of the transmission power further comprises:
transmitting a power transmission change message including the calculated transmission power to a second terminal by the first terminal; and
updating distributed power parameters based on the calculated power transmission power,
wherein the calculation of the transmission power and transmission and update of the power transmission change message are repeated.

11. The method of claim 10, further comprising:
receiving a power transmission change message including the transmission power by the second terminal;
comparing the transmission power included in the power transmission change message with maximum transmission power by the second terminal;
determining an equal or smaller value of the transmission power included in the power transmission change message and the maximum transmission power as the transmission power; and
processing a D2D signal according to the determined transmission power to transmit the processed D2D signal by the second terminal.

12. The method of claim 1, further comprising receiving a message including distributed power control parameters broadcasted from the base station by the first terminal before the calculating of the transmission power.

13. The method of claim 1, further comprising broadcasting a message including distributed power control parameters to peripheral D2D terminals by the first terminal before the calculating of the transmission power.

14. An apparatus for controlling transmission power in a network environment to perform device-to-device (D2D) communication, the apparatus comprising:
a wireless frequency converter configured to transmit/receive a signal through an antenna; and
a processor connected to the wireless frequency converter and configured to control transmission of the signal,
wherein the processor comprises:
a transmission power calculator configured to measure a channel gain and interface with respect to a D2D communication link based on the received signal to calculate D2D transmission power based on the measured channel gain and interface;
an optimal transmission power determining unit configured to determine optimal transmission power based on the calculated transmission power; and
a transmission power change request unit configured to transmit a transmission power change message including the optimal transmission power to a terminal of another party, and
wherein the terminal of the other party transmits a D2D signal based on the optimal transmission power.

15. The apparatus of claim 14, wherein the transmission power change request unit measures an average Signal-to-Interference plus Noise Ratio (SINR) after the optimal transmission power is determined, and transmits a transmission change request message to a base station when the measured average SINR is maintained with a preset level or less for a preset time.

16. The apparatus of claim 15, wherein when a transmission power change request message is received from a D2D communication link of a preset ratio or greater among D2D communication links for a preset time, the base station broadcasts a message for triggering transmission power change of the D2D communication links, and
the apparatus for controlling transmission power again performs transmission power control for determining an optimal transmission power with respect to a corresponding D2D communication link.

17. The apparatus of claim 14, wherein the transmission power change request unit measures an average SINR when the optimal transmission power is determined, and broadcasts a message including a distributed power control parameter to peripheral D2D terminals when the measured average SINR is maintained with a preset level or less for a preset time.

18. The apparatus of claim 14, wherein the optimal transmission power determining unit determines an n-th calculated transmission power as optimal transmission power when a difference between the n-th calculated transmission power and an (n+1)-th calculated transmission power is less than a preset optional value.

19. The apparatus of claim 14, wherein the processor further comprises a power control parameter update unit configured to update a distributed power parameter based on the calculated power transmission power,
wherein the transmission power change request unit transmits a power transmission change message including transmission power corresponding to the transmission power calculated by the transmission power calculator to a terminal of another party.

20. The apparatus of claim 14, wherein the processor comprises:
a transmission power selector configured to select a smaller value of transmission power included in a received power transmission change message and maximum transmission power of the apparatus when a power transmission change message including transmission power is received from a terminal of another party; and
a signal processor configured to process a D2D signal according to the transmission power selected by the transmission power selector to transmit the processed D2D signal to the terminal of the other party.
